(19) United States
(12) Patent Application Publication
(10) Pub. No.: US 2025/0128822 A1
(43) Pub. Date: Apr. 24, 2025

(54) INTEGRATED FAN AND BATTERY PROPULSION SYSTEM

(71) Applicant: QDOT TECHNOLOGY LTD, Oxfordshire (GB)

(72) Inventors: Alasdair MORRISON, Oxfordshire (GB); Jack Robert NICHOLAS, Oxfordshire (GB); Tsun Holt WONG, Oxfordshire (GB); Daniel FAHY, Oxfordshire (GB); Martin ROGALL, Oxfordshire (GB)

(21) Appl. No.: 18/691,992

(22) PCT Filed: Sep. 16, 2022
(86) PCT No.: PCT/GB2022/052355

§ 371 Date: Mar. 14, 2024

(30) Foreign Application Priority Data
Sep. 16, 2021 (GB) 2113272.5

(51) Int. Cl. B64D 33/08; B64D 27/33; B64D 27/357; H01M 10/613; H01M 10/625

(52) U.S. Cl. CPC B64D 33/08; B64D 27/33; B64D 27/357; H01M 10/613; H01M 10/625

(57) ABSTRACT

The present invention provides a battery powered fan assembly (1) for providing motive force, comprising: An electric drive motor (12); a fan (14), connected to and driven by the drive motor (12) and rotatable about a central axis X, for moving a fluid F and to thereby create a flow thereof; a battery (16), electrically connected to and for powering the drive motor (12); a heat management system (18), for managing the temperature T of the battery (16) comprising: a fluid collector (22), for collecting collected fluid Fc from the flow of fluid F moved by the fan (14); a heat exchange means (20), for exchanging thermal energy between the collected fluid Fc and the battery (16); and a fluid director (24) for receiving collected fluid Fc from said fluid collector (22) and directing said fluid Fc to said heat exchange means (20) for thermal management of the battery (16).

### FIELD

The present invention relates to battery powered fans. More particularly, the present invention relates to battery cooling of battery powered fans.

### BACKGROUND

It is common to use electrically powered fans whether they be ducted fans or open rotor fans to provide motive power for vehicles. Aircraft and hovercraft are the most common of these vehicles. The most prevalent power source for these fans have been internal combustion engines (ICE), commonly turbine or piston engines. However, with the need to decarbonise transportation and reduce pollution there is an urgent need to move away from using ICE to power fans.

The latest technology for aircraft uses electrically powered fans that draw their power from batteries or Hydrogen fuel cells. Battery packs require cooling especially during periods of high current draw such as during take-off and landing. In the currently available electrical or hybrid systems used on aircraft, the battery packs and their thermal management systems are located away from the fans elsewhere on the aircraft. Most normally in the fuselage.

This arrangement creates a number of issues. Battery packs and their associated thermal management systems take up a large amount of mass and volume on an aircraft. By locating them away from the fan lengthy connections are required to connect the energy storage and thermal management systems to the fan. In particular the transmission of high current requires weighty copper or less efficient but lighter aluminium conductors. To fulfil the safety requirements of the aviation governing bodies redundancy is required which further increases the mass and volume consumed by the propulsion system. Due to the arrangements discussed, bespoke battery and fan arrangements have to be designed to fit each type of aircraft.

Accordingly, the current invention provides an electric fan propulsion system with an integrated battery cooling solution. The battery pack and thermal management system is integrated into the structure of the electric fan propulsion system, either in the hub or in the surrounding duct/shroud, of a ducted fan or open rotor arrangement that provides motive thrust to a vehicle.

By integrating the battery pack and thermal management system in this manner the overall system mass and volume of the system can be reduced, the air flow created by the main motive fan or rotor can be used directly by the thermal management system for cooling or heating of the battery pack and/or other components, and the propulsion system can be made independent of other airframe design considerations. It will be understood that herein motive fan refers collectively to a ducted fan and an open rotor arrangement.

### SUMMARY OF INVENTION

Aspects of the invention seek to provide an integrated, powerful and efficient cooling solution for batteries and optionally other components in a battery powered fan assembly. A ducted fan or open rotor propulsion system is provided such that the batteries and thermal management system are integrated within the hub and/or the housing surrounding duct of the motive fan used for providing thrust to propel the craft. This system uses the fluid flow F provided by the motive fan in operation to provide cooling for the batteries via said thermal management system within the hub, housing or duct.

According to a first aspect, there is provided a battery powered fan assembly for providing motive force, comprising an electric drive motor; a fan, preferably a motive fan, connected to and driven by the drive motor and rotatable about a central axis X, for moving a fluid F and to thereby create a flow thereof; a battery, electrically connected to and for powering the drive motor; a heat management system, for managing the temperature T of the battery. The battery powered fan assembly may further comprise a fluid collector, for collecting collected fluid Fc from the flow of fluid F moved by the fan. The heat management system may further comprise a heat exchange means, for exchanging thermal energy between the collected fluid Fc and the battery; and a fluid director for receiving collected fluid Fc from said fluid collector and directing said fluid Fc to said heat exchange means for thermal management of the battery.

Increased mass reduces the range of a vehicle and increases the power required to propel a vehicle. By integrating the thermal management system closely together with the battery electric drive motor and control systems in the interior of the housing, in the hub and/or the duct, the total mass and volume of the system can be reduced relative to the systems of the prior art that place fan, battery packs and thermal management systems at different locations around the vehicle. The length of the connections between the components is reduced, reducing the parasitic mass, volume and energy losses associated with such connections. In particular heavy high amp electrical connections and fluid coolant lines have high mass and are expensive.

In a system of the current invention, each battery powered fan assembly includes its own independent battery and thermal management system therefore increasing redundancy and safety.

By using the air or other fluid, herein designated fluid F, moved by the fan, that is the motive fan and the fluid F moved for propelling the vehicle, directly as cooling flow, significant mass and volume savings can be made by not requiring long intermediary coolant loops, and further cooling fans driven by additional motors. In addition, the heated fluid F can be reintroduced into the ducted or open air flow to reduce drag and/or contribute to thrust.

Using the fluid F moved by the motive fan for thermal management of said electrical components, enabled by the location of said components, has the further advantage that the vehicle does not need to be moving for the thermal management system to work and only the motive fan and no auxiliary fans are required in the thermal management system. Peak load occurs when a vehicle is stationary or moving slowly in the early phases of take-off and/or when hovering. In each of these scenarios there is no fluid flow over the surfaces of the vehicle caused by vehicle movement. The current invention uses the fluid flow F caused by the motive fan and therefore provides maximum fluid flow F for thermal management at peak load whether the vehicle is moving or stationary and the vehicle or motor in any orientation.

By incorporating the battery and thermal management components in a self-contained system to provide a modular power solution, the whole system can be used on more different aircraft and operation scenarios without requiring modifications to the airframe in a similar fashion to gas turbines.

The fluid collector and fluid director pass collected fluid Fc through the heat exchange means increasing cooling efficiency whilst not compromising the flow of fluid F from the fan and maintaining efficient thrust and motive power.

Preferably said fan assembly further includes a housing having a surface and an interior for housing said battery. Housing the battery and optionally the power electronics in the housing of the fan assembly places the battery close to the electric drive motor and electric control systems and provides a short path for a cooling flow of collected fluid Fc to reach the heat exchange means connected to the battery, thereby reducing weight and improving cooling and/or heating efficiency of the thermal management system. The housing may be located at one or both of the hub on which the motive fan or rotor is mounted or the structure within which the fan rotates in the case of a ducted fan.

Preferably, the fluid collector comprises an extractor for extracting a portion of the fluid F from the flow thereof. Optionally said fluid extractor may comprise a scoop extending into the flow of fluid F created by said fan. Alternatively said fluid extractor may comprise a flush intake duct below the surface.

The extractor improves efficiency of fluid extraction from the flow of fluid F a scoop may be used to increase the quantity of fluid F collected Fc or a flush duct may be employed to reduce the effect of the collection of fluid Fc on flow of fluid F and increase efficiency of the fan assembly.

Preferably said extractor comprises an opening within the surface of the housing to allow collected fluid to pass into the interior of the housing and pass through the heat exchange means.

Preferably said housing is radially inward of the fan. Alternatively said housing is radially outward of the fan. Said housing may also include a housing radially inward of the fan and a housing radially outward of the fan relative to central axis X. The location of the housing is dependent on the type of fan used for the application of the battery powered fan assembly. For low speed applications an open rotor arrangement with a housing radially inward of the fan may be appropriate or for high speed applications a ducted fan with a housing radially outward of the fan may be appropriate. A ducted fan may have housings both radially inward and radially outward of the fan.

Preferably said housing comprises a circumferentially extending ring extending around the fan and forming an outer boundary confining the flow of any fluid F.

Preferably said heat exchange means is contained within the housing. To allow the fluid director to pass collected fluid Fc to the heat exchange means.

Preferably the heat exchange means is a heatsink attached to the battery and in the flow of collected fluid Fc for exchange of heat between the heat sink and the collected fluid Fc.

Preferably the battery powered fan assembly includes a further source of electricity electrically connected to and for supplying electricity to said drive motor and/or charging said battery. The further source of electricity providing a supply to augment the rate of supply of the battery for high power draw periods or capacity of the battery for longer duration applications.

Preferably, said further source of electricity includes a secondary battery for supplementing the capacity or rate of supply of electricity of the battery.

Preferably, said further source of electricity includes an electrical generator and/or a fuel cell. If a generator is included optionally a source of motive power for driving said generator. Said source of motive power may comprise a gas turbine, internal combustion engine or external combustion engine.

Preferably, said further source of electricity comprises a generator and/or a fuel cell and a secondary battery and wherein said generator and/or fuel cell is electrically connected to said secondary battery for charging said secondary battery.

The generator driven by a source of motive power and/or fuel cell allow a more energy dense consumable source of power, for example hydrogen or fossil fuel, to be carried on the vehicle increasing range without increasing the weight as much as if batteries were used to provide the same extra capacity.

Preferably the battery powered fan assembly includes a fan drive connection between the source of motive power and the fan for transferring motive power from the source of motive power to the fan for assisting the electric drive motor in driving the fan. Thus, on occasions where it is more efficient to drive the fan directly from the source of motive power and avoid two changes of state of energy.

Preferably the battery powered fan assembly further comprises a generator drive connection between the fan and the generator for driving the generator when the flow of fluid F is driving the fan. Thus, when a vehicle such as an aircraft is decelerating or descending the flow of fluid F can be harnessed to charge the battery.

Preferably the electric drive motor and the generator are a combined motor generator to save the weight and complexity of including and packaging two separate components in the fan assembly, in particular in the hub.

Preferably the battery or the second battery comprises capacitors or supercapacitors for storing and providing electricity to the fan assembly. Capacitors or supercapacitors used as the battery or to assist a chemical electrical storage means are fast to charge and discharge and can provide increased peak power density compared to chemical electrical storage means. However, they have lower energy density.

Preferably, the heat exchange means includes a heat pump having a refrigerant circuit connected to a refrigerant heat exchanger for exchanging heat energy between the refrigerant circuit and the collected fluid Fc. The heat pump increases the thermal gradient between the heat exchange means and the collected fluid Fc or fluid F passing through the heat exchange means and therefore increasing the rate of exchange of heat energy between the two.

Preferably, the heat pump is operable a first heating mode for heating the battery and a second cooling mode for cooling the battery and the heat pump includes a reversing valve for reversing flow of the refrigerant circuit having a first position in the first heating mode and a second position in the second cooling mode. Thermal management of the battery includes both heating and cooling allowing the battery to be maintained at the correct temperature for optimum efficiency to be achieved at all times.

Preferably, the battery powered fan assembly comprises power electronics, and gearbox wherein the refrigerant circuit is connected to one or more of the power electronics, the electric motor and the gearbox.

Preferably, the battery powered fan assembly comprises power electronics, and a gearbox wherein the refrigerant circuit is connected to one or more of the power electronics, the electric motor and the gearbox.

Preferably, the refrigerant circuit includes a flow control means for excluding one or more of the battery, the power electronics, the electric motor and the gearbox from the refrigerant circuit. This allows the temperature of the individual components to be managed and prioritised independently.

Preferably, the heat exchange means includes a coolant circuit connected to and for exchanging heat energy with at least the battery and further connected to a coolant heat exchanger for transferring heat energy to or from the coolant circuit. The coolant circuit is a closed fluid tight loop that contains coolant for absorbing and transferring heat energy. Coolant of a coolant circuit has a greater heat capacity compared to the fluid F so is more efficient at transferring heat from at least the battery. The high heat capacity also provides thermal inertia to the system in case of periods of high thermal energy production.

Preferably, the coolant heat exchanger is positioned in the flow of captured fluid Fc for transferring heat energy between the captured fluid Fc and the coolant circuit. In the case where the thermal gradient or difference in temperature between the heat exchange means and the fluid F or collected fluid Fc is sufficient to achieve the desired rate of transfer of heat energy with only a coolant circuit such a solution may be efficient and provide good thermal inertia. It should be noted that a coolant circuit may provide both heating and cooling in a heat management system.

Preferably, the coolant heat exchanger is further connected to the refrigerant circuit for transferring heat energy between the refrigerant circuit and the coolant circuit. When an increased rate of transfer of heat energy between the heat exchange means and the fluid F or collected fluid Fc is required to meet the thermal management needs of at least the battery, a heat pump, having a refrigerant circuit, may be provided in combination with the coolant circuit to increase the thermal gradient between the heat transfer means and the Fluid F or collected fluid Fc. The heat pump will transfer heat out of the coolant circuit at a greater rate than if the coolant circuit and the coolant heat exchanger were directly cooled by the fluid F.

Preferably, the battery powered fan assembly comprises power electronics, and a gearbox wherein the coolant circuit is connected to one or more of the power electronics, the electric motor and the gearbox to provide heat management thereof.

Preferably, the coolant circuit includes a flow control means for excluding one or more of the battery, the power electronics, the electric motor and the gearbox from the coolant circuit.

Thereby allowing optimal and independent thermal management for each of the components.

Preferably, the housing has a leading edge, a trailing edge and a return injector for receiving collected fluid Fc after it has been passed through the heat exchanger and returning it to the remainder of the fluid flow F at the trailing edge of the housing. Reintroduction of the collected fluid Fc after energy has been added from the heat management system will reduce drag and increase thrust, in particular returning the collected fluid Fc to the remainder of the fluid flow F at the trailing edge will be highly efficient as this is a point of low pressure at the rear of the housing which causes drag.

Preferably, the heat exchange means includes a passage through the battery for coolant of the coolant circuit or refrigerant of the refrigerant circuit to pass through for direct transfer of heat energy between the battery and said coolant or refrigerant.

Preferably, the heat exchange means includes a passage through the battery for collected fluid Fc to pass through for exchange of thermal energy between the battery and the collected fluid Fc by direct transfer of heat from the battery to the collected fluid Fc.

Preferably, the battery powered fan assembly further includes a thermal storage device for temporary storage of heat energy. The thermal storage device may include a precooling connection connectable to a cooler for pre-cooling the thermal storage device to increase heat capacity.

The thermal storage device increases the thermal capacity and thus thermal inertia of the heat exchange system, the thermal storage device can absorb heat energy when the battery or other components are under high load and creating more heat than the heat management system can transfer to the fluid F or collected fluid Fc. Absorbed heat may be returned to the heat management system for transfer to the fluid F or collected fluid Fc when the heat management system has capacity or used to increase the temperature of the battery at a later point if required.

In a complementary embodiment, a vehicle such as an aircraft comprising one or more of the battery powered fan assemblies of the current invention is provided.

### BRIEF DESCRIPTION OF DRAWINGS

Embodiments will now be described, by way of example only and with reference to the accompanying drawings having like-reference numerals, in which:

FIG. 1 shows a battery powered fan assembly according to the current invention including a housing radially outward of the fan in a ducted fan arrangement;

FIG. 2 shows a front view of the battery powered fan of FIG. 1;

FIG. 3 shows the cross section view of the battery powered fan assembly of FIGS. 1 and 2 along line A-A shown in FIG. 2; and

FIG. 4 shows the cross section view of FIG. 3 including arrows indicating the flow of a fluid F;

FIG. 5 shows a battery powered fan assembly according to the current invention including a housing radially inward of the fan in an open rotor arrangement;

FIG. 6 shows a cross section view of FIG. 5 through taken through the central axis X;

FIG. 7 shows the cross section view of FIG. 6 including arrows indicating the flow of a fluid F;

FIG. 8 shows a cross section view of a battery powered fan assembly according to the current invention including a ducted fan having both a housing radially outward of the fan and a housing radially inward of the fan and including arrows indicating the flow of a fluid F through the battery powered fan assembly.

FIG. 9 shows a cross section view of a battery powered fan assembly according to the current invention.

FIG. 10 shows a possible thermal transfer layout according to the current invention including a heat pump circuit and a coolant circuit in a battery heating mode;

FIG. 11 shows the thermal transfer layout of FIG. 8 in a heat pump circuit and a coolant circuit in a battery cooling mode;

FIG. 12 shows an alternative thermal transfer layout according to the current invention similar to FIGS. 8 and 9;

FIG. 13 shows a thermal transfer layout including only a heat pump in a cooling mode;

FIG. 14 shows a thermal transfer layout similar to that in FIG. 13 including a bypass of one or more components;

FIG. 15 shows the thermal transfer layout of FIG. 14 in a heating mode;

FIG. 16 shows a further possible thermal transfer layout according to the current invention including a coolant loop with an optional bypass route in the coolant circuit;

FIG. 17 shows possible arrangements for the components that may be applied to any of the thermal transfer layouts in FIGS. 8 to 14; and

FIG. 18 shows an electrical layout according to the current invention.

### SPECIFIC DESCRIPTION

A battery 16 performs best when run at an optimum temperature. With the currently available technology, the battery likely to power the fan assembly 1 of the current invention would be a lithium battery 16, however, it will be understood that as technology progresses other battery chemistry may evolve that is more suitable and could be used with the current invention. A lithium battery can work between 0 and 60 centigrade, works best in the range 10-40 centigrade, with the optimum temperature varying depending on the load case placed on the battery. It will be understood that as electrical storage technology evolves and for example new electrical storage technologies or battery chemistries are introduced the optimum temperature for battery operation may change. Prior to use, when a fan assembly 1 has been sitting, the battery 16 may be below the optimum temperature and therefore the thermal management system 18 may need to increase the temperature of the battery 16 and when in use the battery 16 generates heat and may increase in temperature above the optimum temperature in which case the thermal management system 18 may need to reduce the temperature of the battery 16. In particular, during periods of rapid discharge, such as required during take-off if the fan assembly 1 is installed on an aircraft, excessive heat can be generated. Therefore, thermal management is required to maintain the battery 16 at or near the optimum temperature to maximise efficiency.

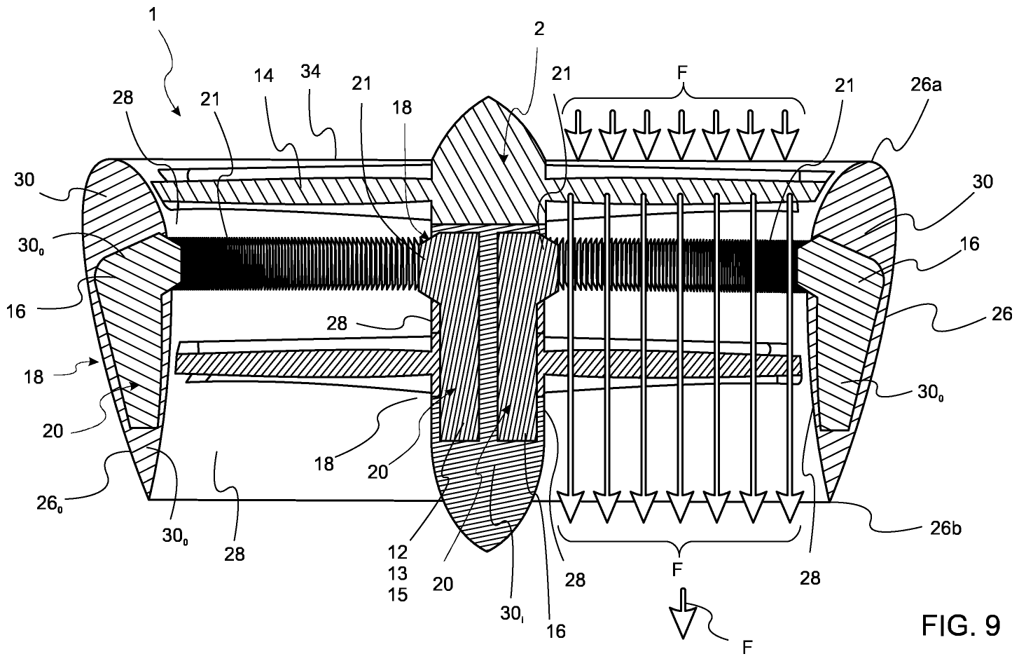

In a first embodiment of the invention is shown in FIG. 9 comprising a battery powered fan assembly 1. The fan assembly 1 includes a fan 14 rotatable about a central axis X and rotatably mounted at a central hub 2. An electric drive motor 12, is connected to and for driving rotation of the fan 14, is located in the hub 2, and is electrically connected to and powered by a battery 16. The motor 12 provides motive power for the fan 14 which moves a fluid F for providing thrust, said fan 14 is therefore also known as a motive fan 14. In a preferred embodiment the fluid F is air. The fan assembly 1 further includes a housing 26 having an outer surface 28 facing the fluid F over which the fluid F flows, and an interior 30 in which the battery 30 is located. The fan assembly 1 also includes a heat management system 18 for thermal management of the temperature T of the battery 16. The thermal management system 18 includes a heat exchange means 20 which includes a heat sink 21 for exchanging heat energy between the battery 16 and the fluid F. It will be understood that a more complex heat exchange means 20 such as those described below may be used in place of or between the battery 16 and the heat sink 21 as described below. In FIG. 9 the housing 26 includes a housing 260 radially outward of the fan 14 in a ducted fan arrangement and a housing 26i radially inward of the fan 14 each housing 260, 26i having a respective interior 300 and 30i and respective outer surfaces 28o 28i. It will be understood that the housing 26 may also be only radially inward of the fan 14 in the case of an open rotor arrangement or only radially outward of the fan 14. To maximise heat transfer a high thermal gradient must be maintained at a thermal transfer means 20 and a high surface area exposed to the flow of fluid F. The heat sink 21 may be a thin walled heat sink 21 produced using additive manufacturing techniques and extends from the surfaces 28i 280 of the housings 26i, 260 into the flow of fluid F down stream of the fan 14 or down stream of at least the first of one or more fans 14. Thus, as the fan 14 is run the fluid F flows through the heat sink 21 and the battery 16 is cooled. At times of high current draw the fan 14 will be moving a greater mass of fluid F at a higher velocity, therefore, during these times of increased cooling requirement there will automatically be greater air flow and thus greater cooling as a greater temperature gradient is achieved.

In the context of the current invention a heat sink 21 is a passive heat exchanger that transfers the heat generated by an electronic or a mechanical device to a fluid, for the current invention the fluid is the fluid F moved by the motive fan 14 to create motive thrust to propel the vehicle.

For example a heatsink 21 may be a simple finned metallic structure or a more complex variable density triply periodic minimal structure with a thermal interface with said electronic or a mechanical device for example the battery pack 16, power electronics 13 or motor 12 of the current invention.

The skilled person will understand that features introduced in one embodiment may be included in another embodiment as is beneficial to that embodiment. The same reference numerals are used for like features across all embodiments.

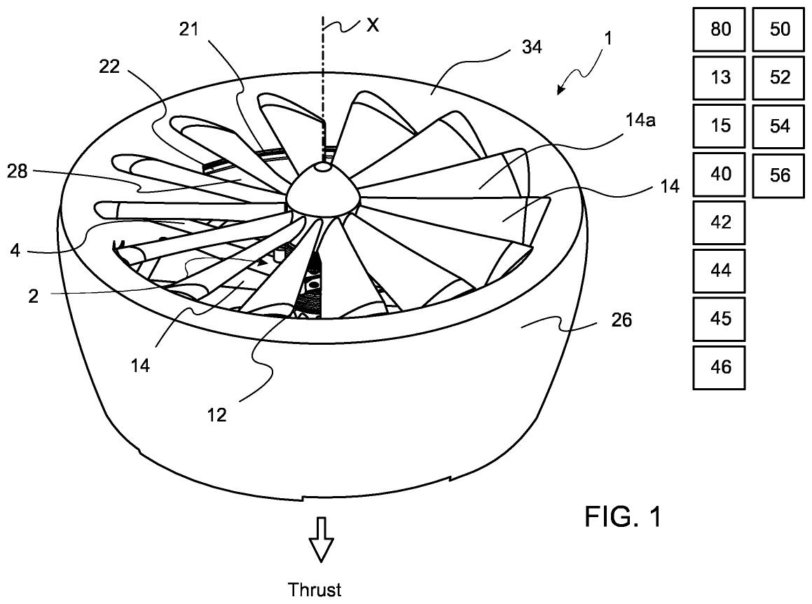

Referring to FIG. 1, a second embodiment according to the current invention, that builds on the features of the first embodiment will now be described. FIG. 1 shows a complete battery powered fan assembly 1 including a housing 26 or shroud 26 and a fan 14. The fan 14 is rotatable about a central axis X, connected to and driven by an electric drive motor 12. The electric drive motor 12 is electrically connected to and powered by a battery 16. When the fan 14 is driven by the motor 12 the fan 14 moves a fluid F for providing thrust and thus motive power. One or more fan assemblies 1 may be the main source of thrust or motive power for the vehicle. The housing 26 includes a surface 28 over which a fluid F flows. It will be understood that it is possible to include one or more fans 12 connected to one or more electric drive motors 12 as required by the application.

The fan 14 and preferably the electric drive motor 12 are mounted at a central hub 2 located at or near the central axis X. In the embodiment of FIG. 1 the housing 26 is located radially outward of the fan 14. Such an arrangement is known as a ducted fan assembly 1. The central hub 2 is connected to the housing 26 by one or more supporting pylons 4 which may support the hub 2 and the housing 26 and/or transfer fluids and electrical power between the hub 2 and the housing 26.

The fan 14 has a plurality of blades 14a and through the blades in FIG. 1 can be seen part of a heat management system 18 for thermal management of at least a battery 16. The heat management system 18 may also cool the electrical drive motor 12, power electronics 13, and/or a gearbox 15. The heat management system 18 includes a fluid collector 22, for collecting fluid Fc from the flow of fluid F moved by the fan 14. Such fluid will be referred herein as collected fluid Fc. Within the housing 26 a heat exchange means 20 can be seen, through which collected fluid Fc is directed by a fluid director 24. The heat exchange means 20 may be by direct air cooling of the battery 16 and include a passage 17 through or around the battery 16 through which collected fluid Fc may pass to exchange heat energy between the collected fluid Fc and the battery 16 directly by conduction or convection. The heat exchange means 20 may comprise alternative passive heat exchange means 20 such as a heatsink 21, mounted to and in thermal contact with the battery 16, through which collected fluid Fc may flow or the heat exchange means 20 may comprise a more complex thermal layout such as those described below.

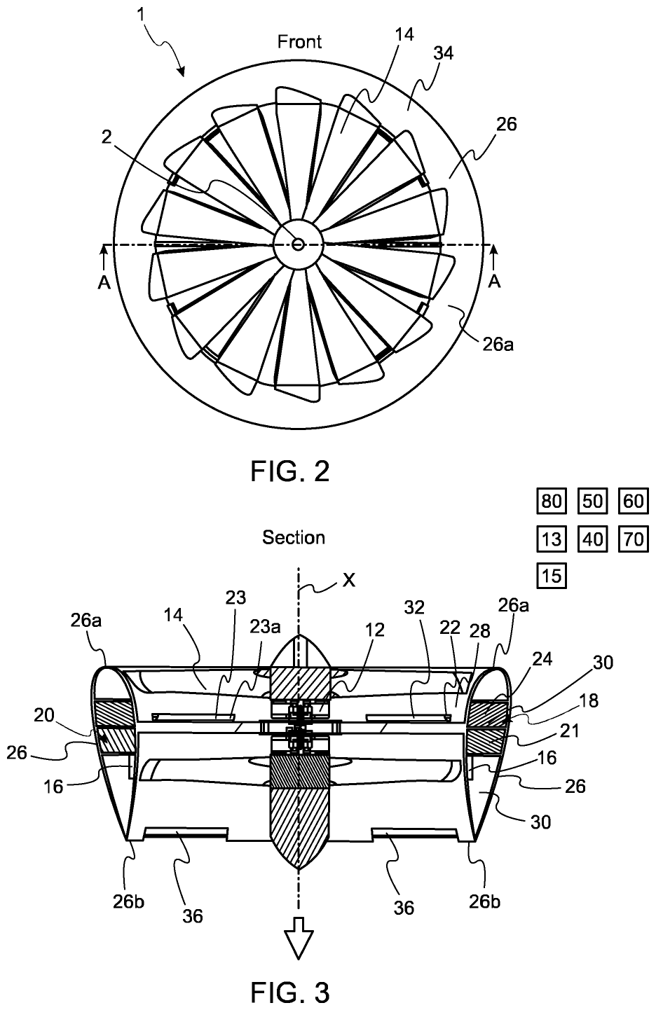

FIG. 2 shows a front view of the battery powered fan assembly of FIG. 1 including cross section line A-A. The housing 26 has a leading edge 26a and a trailing edge 26b. In FIG. 2 the leading edge 26a of the housing 26 forms a circumferentially extending ring 34 around the fan 14, forming an outer boundary confining the flow of any fluid F.

FIG. 3 shows the cross section A-A including the housing 26 having an interior 30 in which the battery 16 and at least part of the heat exchange means 20 is housed. In FIG. 3 central Axis X can be more clearly seen about which the one or more fans 14 are rotatable. The one or more fans 14 are connected to and driven by one or more electric drive motors 12. The one or more electric drive motors 12 may be connected to the hub 2. FIG. 3 further shows the fluid collector 22 is located in the flow of fluid F extending from the surface 28 of the housing 26 presented to the flow of fluid F into the fluid F. The collector 22 can be seen to include an extractor 23 for extracting a portion of the fluid F from the fluid flow, in the form of a scoop 23a protruding from the surface 28 of the housing 26 into the flow of the fluid F moved by the fan 14 for collecting fluid F. Whilst a scoop 23a is shown it will be understood that a flush intake duct 23b housed below the surface 28 of the housing 26 may also be used, for example a NACA duct. The collector 22 is preferably downstream of the fan 14 or at least the first of the one or more fans 14. The interior 30 of the housing can be seen in which the battery 16 and the fluid director 24 is located with other components of the heat management system 18 including part or all of the heat exchange means 20. The fluid director 24 receives collected fluid Fc from the collector 22 and directs the collected fluid Fc to the heat exchange means 20 for thermal management of the battery 16. After the heat exchange means 20 the fluid Fc may be further directed by the fluid director 24 towards a return injector 36, preferably located in an area of low pressure, such as at the trailing edge 26b of the housing 26 for return to the main flow of fluid F. Such fluid injection at the trailing edge 26b is known to reduce drag and the energy imparted to the collected fluid Fc by the thermal management system 18 will accelerate the fluid to further reduce losses associated with transit through the thermal management system 18.

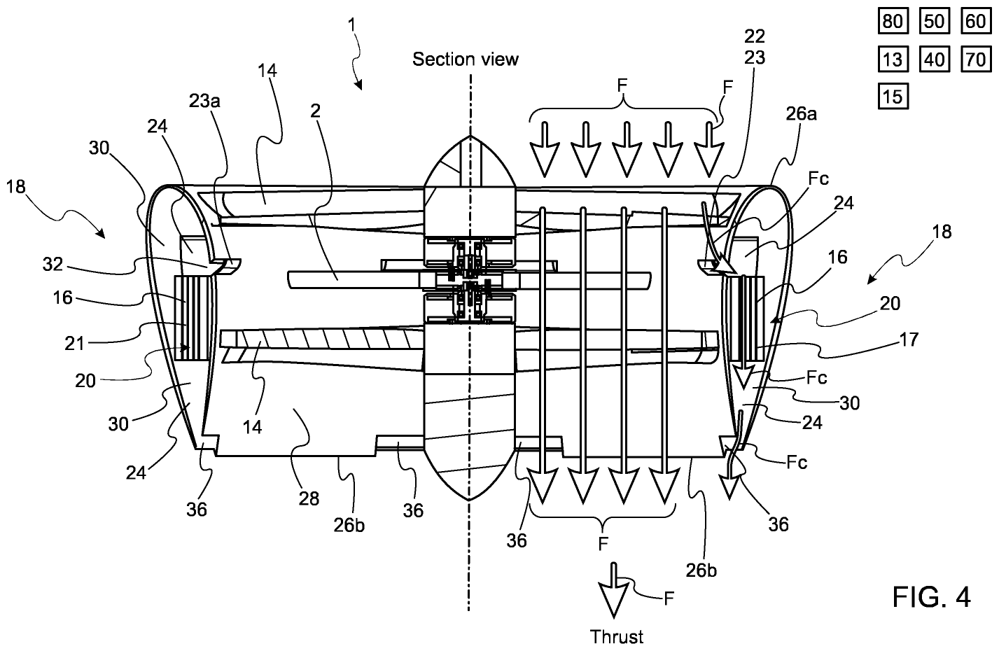

FIG. 4 shows the cross section view of FIG. 3 with the addition of arrows showing the flow of fluid F and collected fluid Fc. Fluid F is collected down stream of at least the first of one or more fans 14 by the collector 22. Said collected fluid Fc is directed by the fluid director 24 through the heat transfer means 20 of the heat management system 18 for heating or cooling of at least the battery 16. The collected fluid Fc is further directed to the return injector 26 by the fluid director 24 after exiting the heat exchange means 20.

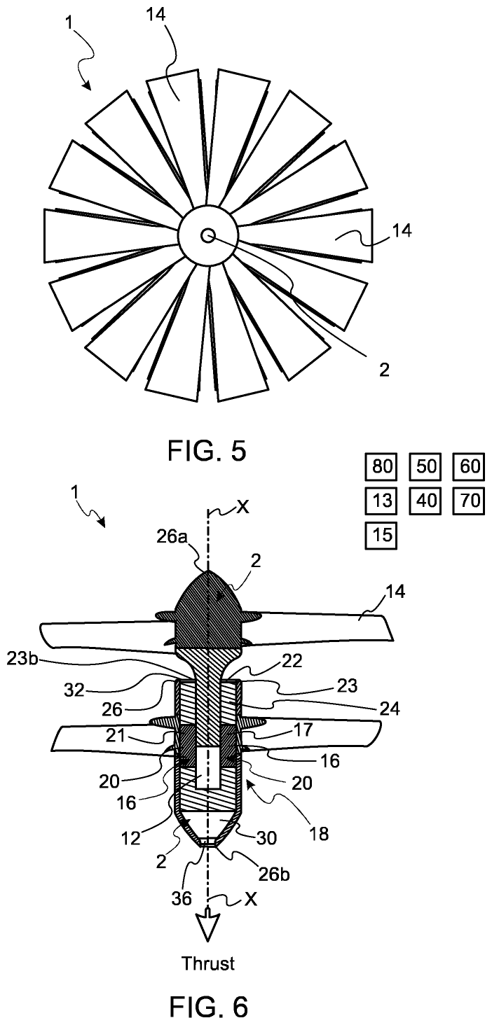

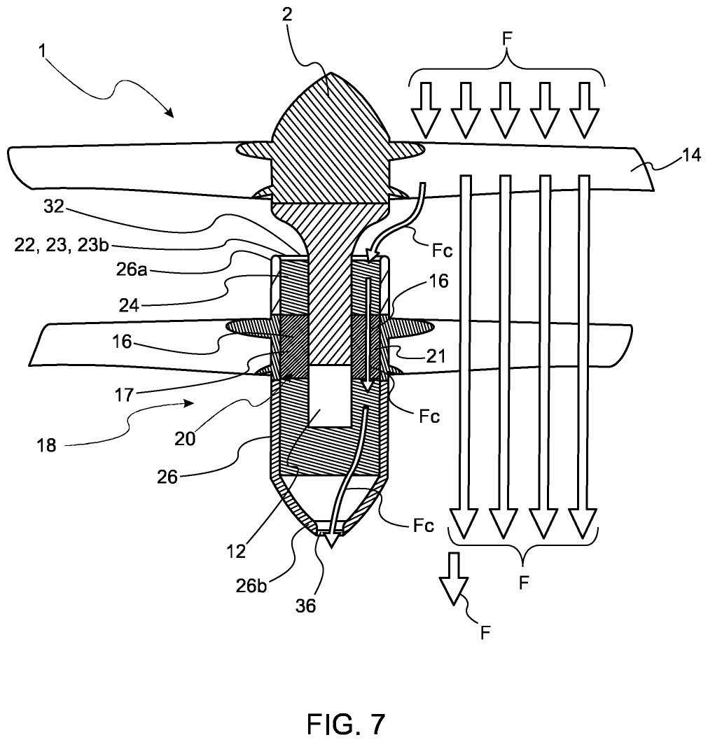

FIGS. 5,6 and 7 show an alternative arrangement of the second embodiment including the same features as FIGS. 1, 2 3 and 4 having the same function, however, some features are arranged in a different position as described below. The housing 26 is located radially inward of the fan 14 to provide an arrangement known as an open rotor system. Thus, the housing 26 forms part of the central hub 2 and surrounds axis X. The electric drive motor 12, the battery 16, and the thermal management system 18 are thus all located at the central hub 2. The flow of the fluid F can be seen in FIG. 7. A fluid collector 22, for collecting collected fluid Fc from the flow of fluid F moved by the fan 14 is shown. Captured fluid Fc enters the housing at the collector 22 downstream of at least the first fan 14 of the one or more fans 14. The collector 22 comprises an extractor 23 for extracting a portion of the fluid F from the flow thereof. The extractor 23 comprises a flush intake duct 23b below the surface 28 of the housing 26. However, it will be understood that the extractor 23 may comprise a scoop 23a extending into the fluid F created by the fan 14. The scoop 23a may extend from the surface of the housing 28 in to the flow of fluid F. A fluid director 24 for receiving collected fluid Fc from said fluid collector 22 and for directing the fluid F to the heat exchange means 20 is shown. Again, in this embodiment the heat exchange means 20 is a heatsink 21. It will be understood that more complex heat exchange means 20 may be used as discussed below.

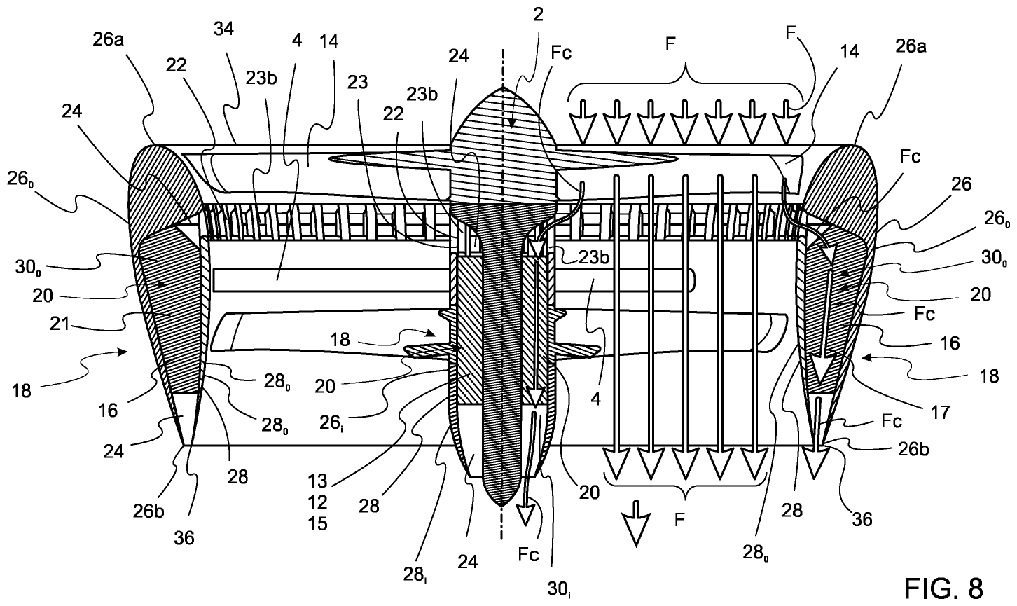

In a further alternative arrangement of the second embodiment shown in FIG. 8, a battery powered fan assembly 1 may include a housing 26i having an interior 30i located at the hub 2 radially inward of the fan 14 and a housing 260 having an interior 300 located radially outward of the fan 14. The two housings 26i, 260 include all the features of the arrangements described in FIGS. 1-7 above and such features have the same function and are given the same reference numeral. In such an arrangement, components including the electric drive motor 12, the power electronics 13, the gearbox 15 and the battery 16 may be located in either or both the housing 26i located radially inward of the fan 14 and/or in housing 260 located radially outward of the fan 14. In a preferred arrangement the battery 16 is located in the interior 300 of the housing 260 radially outward of the fan and the electrical drive motor 12, gearbox 15 and the power electronics 13 are located in the interior 30i housing 26 located radially inward of the fan. In such an arrangement the thermal management system 18 may be present in both housings 26i 260 if for example said components require increased cooling or the arrangement provides weight or packaging benefits. Preferably the heat management system 18 is located in both housings 26i 260 with each including a collector 22 and drawing fluid F into both interiors 30i, 300 of both housings 26i 260 where the fluid director 24 directs collected fluid Fc through heat exchange means 20 for exchanging heat energy between the collected fluid Fc and at least the battery 16. Such an arrangement includes the flow paths of fluid F and collected fluid Fc in the housing 26i inward of the fan and the housing 260 outward of the fan shown in FIG. 8. After the heat exchange means 20 the fluid director 24 further directs collected fluid to the return injector 36 at the trailing edge of the two housings 26i, 260 for contributing to thrust.

The above arrangements describe a single battery powered fan assembly 1, however, it will be understood that a vehicle, such as an aircraft, may be powered by one or more battery powered fan assemblies 1 as required. Each battery powered fan assembly 1 may include one or more fans 14 and one or more electrical drive motors 12, powered by one or more batteries 16 located within the interior 30 of the housing 26, to suit the power and packaging requirements of the vehicle.

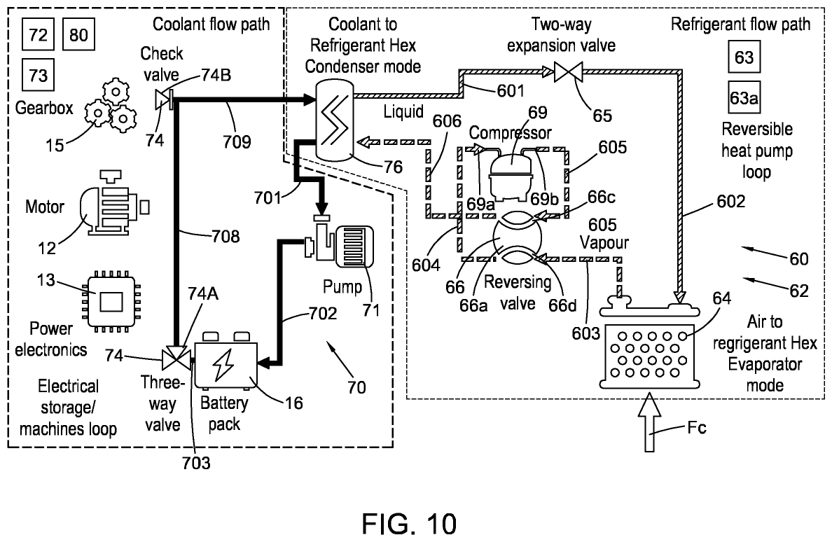

Above, arrangements including the heat exchange means 20 comprising passive cooling apparatus have been described including direct air cooling or a heatsink 21 over which collected fluid Fc is passed to manage the temperature of at least the battery 16. There are occasions where such an arrangement is not sufficiently powerful to achieve the required rate of heat transfer. This may be the result of the ambient temperature of the fluid F or the rate of heat generation in the components being serviced by the thermal management system 18. FIGS. 10 to 16 show alternative active heat exchange means 20 that provide improved thermal transfer and/or increased thermal inertia in the thermal management system 18 to provide the required improved thermal management performance. Each of the heat exchange means 20 discussed below can be used in any of the configurations of fan 14 and housing 26 discussed above.

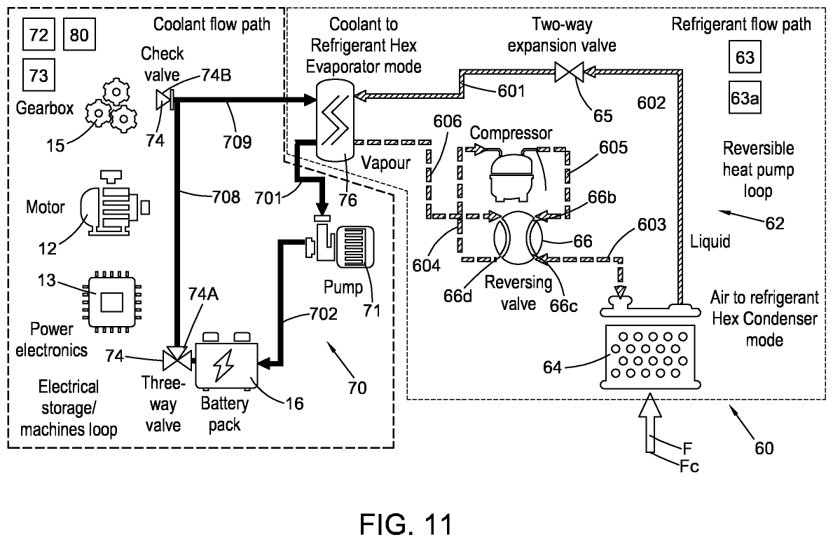

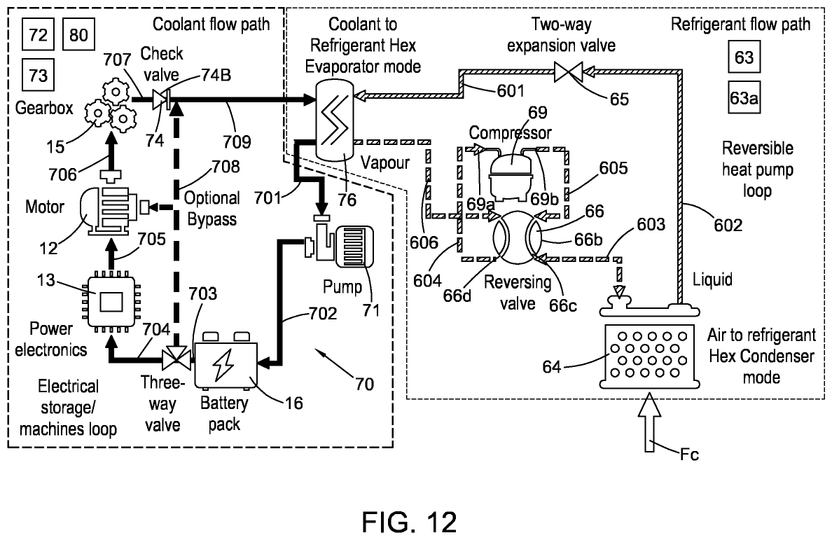

FIGS. 10, 11 and 12 show the same heat exchange means 20 in three different arrangements. Each comprise a coolant circuit 70 and a heat pump 60 including a refrigerant circuit 62 for increasing the thermal gradient between the heat exchange means 18 and the fluid F or collected fluid Fc. Thereby, increasing the rate of heat transfer achieved by the heat management system. The heat exchange means 18 may operate in a heating mode as shown in FIG. 10 and a cooling mode as shown in FIGS. 11 and 12 as appropriate. In the heating mode the heat management system 18 can be used to increase the temperature of at least the battery pack 16 and optionally one or more of the power electronics 13, motor 12 and/or gearbox 15 to bring it into an optimum operating window for maximum efficiency. In the cooling mode the heat management system 18 cools at least the battery 16 and optionally one or more of the power electronics 13, motor 12 and/or gearbox 15 to maintain the temperature in said optimum temperature window.

In FIG. 10 the coolant circuit 70 includes a pump 71 for circulating coolant around the coolant circuit 70 connected to and for exchanging heat energy with at least the battery 16. The coolant circuit 70 may also include the coolant heat exchanger 76 for exchanging heat energy into and out of the coolant circuit 70. In FIGS. 10, 11 and 12 the coolant heat exchanger 76 is connected to the refrigerant circuit 62 for exchanging heat energy between the coolant circuit 70 and the refrigerant circuit 62. The coolant/refrigerant heat exchanger 76 may be a fluid to fluid heat exchanger. The refrigerant circuit 62 is a closed fluid tight loop containing a refrigerant for absorbing and transferring heat energy. The coolant circuit 70 is further connected to thermally managed components 12, 13, 15, 16. Said thermally managed components comprising at least the battery 16 and may further include any of the power electronics 13, the electrical drive motor 12 and/or the gearbox 15. Connections to the coolant circuit 70 are fluid tight connections and for the thermally managed components 12, 13, 15, 16, connected to means that said components are included in the circuit for the purpose of exchanging heat energy with the coolant. This may be by conduction or convection from direct contact with coolant flowing through the component or by an intermediate thermal interface such as a heat sink or heat exchanger. The coolant circuit 70 may further include a flow control means 72 for modifying the flow of the coolant in the coolant circuit 70. The flow control means 72 may include a coolant flow controller 73 connected to one or more valves 74 for disconnecting or bypassing one or more of the battery 16, the power electronics 13, the electrical drive motor 12 or the gearbox 15 from the coolant circuit 70. In a preferred arrangement the one or more valves 74 include a three way valve 74A before the bypassed thermally managed component 12, 13, 15, 16 and a check valve 74B after the bypassed thermally managed component 12, 13, 15, 16. Connection to the coolant circuit 70 comprises a fluid tight connection and a thermal interface for transfer of heat energy between the coolant circuit 70 and the connected component 71, 76, 12, 13, 15, 16. The heat exchange means 20 may include a passage 17 through the battery 16 and/or other components for coolant of the coolant circuit 70 to pass through for direct transfer of heat energy between the battery 16 and said coolant. Alternatively, the heat exchange means 18 may include an intermediate thermal interface such as a heat sink for transferring thermal energy between each thermally managed component 12, 13, 15, 16 and the coolant of the coolant circuit 70. In a preferred embodiment the battery 16 will be the first thermally managed component 12, 13, 15, 16 in the coolant circuit 70 after the coolant heat exchanger 76. It should be noted that the pump 71 is shown in a preferred location between the coolant heat exchanger 76 and the battery back 16 however the pump 71 can be located at any point in the coolant circuit 70 except a point that may be optionally bypassed.

In a preferred arrangement the coolant heat exchanger 76 is fluidly connected to the pump 71, the pump 71 is fluidly connected to the components to be cooled, the one or more valves 74 are operable by a user or by the coolant flow controller 73 to bypass one or more thermally manged components. The one of more valves 74 may include a three way valve 74A before a thermally manged component to be bypassed and a check valve 74b after the thermally managed component to be bypassed the three way valve 74A and the check valve 74B connected by an optional bypass connection 708. The coolant circuit 70 provides the advantage of greater thermal transfer and greater thermal inertia due to the heat capacity of the coolant.

In the preferred embodiment displayed in FIG. 10 the coolant circuit 70 is displayed with the optional bypass 708 activated to bypass the power electronics 13 the motor 12 and the gearbox 15. In this configuration the coolant circuit 70 includes a first coolant connection 701 between the coolant heat exchanger 76 and the pump 71; a second coolant connection 702 between the pump 71 and the battery 16, a third coolant connection 703 between the battery 16 and the three way valve 74A, an eight coolant connection 708 between the three way valve 74A and the check valve 74B and a ninth coolant connection 709 between the check valve and the coolant heat exchanger 76. The eight coolant connection 708 is also known as the optional bypass connection 708 referred to above.

FIGS. 11 and 12 show the same coolant circuit as FIG. 10. In FIG. 12 the optional bypass 708 is not activated. Therefore, in addition to first, second, third and ninth coolant connections 701, 702, 703, 709 present in FIG. 10 there is a further fourth coolant connection 704 between the three way valve 74a with the power electronics 13, a fifth coolant connection 705 between the power electronics 13 and the motor 12, a sixth coolant connection 706 between the motor 12 and the gearbox 15 and a seventh coolant connection between the gearbox 15 and the check valve 74b. An alternative optional by pass is included in FIG. 12 which only excludes the power electronics 13 from the coolant circuit 70. It will be understood that any one or more of the thermally managed components can be bypassed.

The heat pump 60 includes a refrigerant circuit 62 connected to a refrigerant heat exchanger 64 for exchanging heat energy between the refrigerant circuit 62 and the collected fluid Fc. Preferably the heat pump 60 is a reversable heat pump 60 and includes a reversing valve 66 for reversing flow of the refrigerant circuit 62. Said reversing valve having a first position 66a and a second position 66b. When the heat pump 60 includes the reversing valve 66 the heat pump 60 is operable in a first cooling mode 60a when the reversing valve 66 is in the first position 66a and a second heating mode 60b when the reversing valve 66 is in the second position 66b. The refrigerant circuit 62 is further connected to the coolant heat exchanger 76 for exchanging heat energy between the refrigerant circuit 62 and the coolant circuit 70, a two way expansion valve 65, and a compressor 69. The compressor 69 having a low pressure input 69a and a high pressure output 69b.

The refrigerant circuit 62 includes a first refrigerant connection 601 fluidly connected to the coolant heat exchanger 76 and the two way expansion valve 65; a second refrigerant connection 602 fluidly connected between the two way expansion valve 65 and the refrigerant heat exchanger 64; a third refrigerant connection 603 connected between the refrigerant heat exchanger 64 and the reversing valve 66; a fourth refrigerant connection 604 connected between the reversing valve 66 and the low pressure input 69a of the compressor 69; a fifth refrigerant connection 605 connected between the high pressure output 69b of the compressor and the reversing valve 66; and a sixth refrigerant connection 606 fluidly connected between the reversing valve 66 and the coolant heat exchanger 76.

The reversing valve includes a first reversing valve connection 66c and a second reversing valve connection 66d. Each reversing valve connection 66c, 66d fluidly connects one refrigerant connection 603, 604, 605, 606 to one other refrigerant connection 603, 604, 605, 606.

FIG. 10 shows the heat pump 60 in the first heating mode 60a for exchanging heat from the fluid F or collected fluid Fc to at least the battery 16 and the reversing valve 66 is in the first position 66a. In the first position 66a the first reversing valve connection 66c connects the fifth refrigerant connection 605 to the sixth refrigerant connection 606 and thus connects the high pressure output 69b of the compressor 69 to the coolant heat exchanger 76. In the first position 66a the second reversing valve connection 66d connects the third refrigerant connection 603 with the fourth refrigerant connection 604 and thus connects the refrigerant heat exchanger 64 to the low pressure input 69a of the compressor 69. Thus, the high pressure output 69b of the compressor 69 is connected to the Coolant heat exchanger 76, which is connected to the two way expansion valve 65 which is connected to the refrigerant heat exchanger 64, which is connected to the low pressure input 69a of the compressor 69. Refrigerant flows from the high pressure outlet 69b to the low pressure input 69a of the compressor 69. Refrigerant will condense in the coolant heat exchanger 76 as it gives out heat energy and evaporate in the refrigerant heat exchanger 64 when receiving heat energy from the fluid F or collected fluid Fc

The heat pump 60 may further include a flow control means 63 including a flow controller 63a connected to the compressor 69 and the reversing valve 66 and operable to turn the compressor 69 on and off and move the reversing valve depending on the temperature of at least the battery 16.

It will be understood that if a heat pump 60 without a reversing valve 66 is used in the first heating mode 60a third and fourth refrigerant connections 603, 604 will be combined to connect the coolant heat exchanger 64 to the low pressure input 69a of the compressor 69 and the firth and sixth refrigerant connections 605, 606 for connecting the high pressure output 69b of the compressor 69 to the coolant heat exchanger 76.

In FIGS. 11 and 12 the same heat pump 60 is shown as in FIG. 10 however, the refrigerant circuit is in the second cooling mode 60b with the reversing valve in the second position 66b. In the second cooling mode 60b all refrigerant connections 601, 602, 603, 604, 605, 606 remain the same. The reversing valve 66 in the second position 66b includes the first reversing valve connection 66c between the third refrigerant connection 603 and the fifth refrigerant connection 605 connecting the high pressure output 69b of the compressor 69 with the refrigerant heat exchanger 64. The reversing valve 66 in the second position 66b further includes the second reversing valve connection 66d between the sixth refrigerant connection 606 and the fourth refrigerant connection 604 connecting the low pressure input 69a of the compressor 69 with the coolant heat exchanger 76. Thus, the high pressure output 69b of the compressor 69 is connected to the refrigerant heat exchanger 64, which is connected to the two way expansion valve 65 which is connected to the coolant heat exchanger 76, which is connected to the low pressure input 69a of the compressor 69. Refrigerant flows from the high pressure outlet 69b to the low pressure input 69a of the compressor 69 and thus the refrigerant flows in the opposite direction in the cooling mode 60b compared to the heating mode 60a.

Refrigerant will condense in the refrigerant heat exchanger 64 as it gives out heat energy to the fluid F or collected fluid Fc and evaporate in the coolant heat exchanger 76 when receiving heat energy from the coolant circuit 70.

It will be understood that if a heat pump 60 without a reversing valve 66 is used in the second cooling mode 60b third and fifth refrigerant connections 603, 605 will be combined to connect the high pressure output 69b of the compressor 69 with the refrigerant heat exchanger 64 and the sixth and fourth refrigerant connections 606, 604 for connecting the low pressure input 69a of the compressor 69 with the coolant heat exchanger 76.

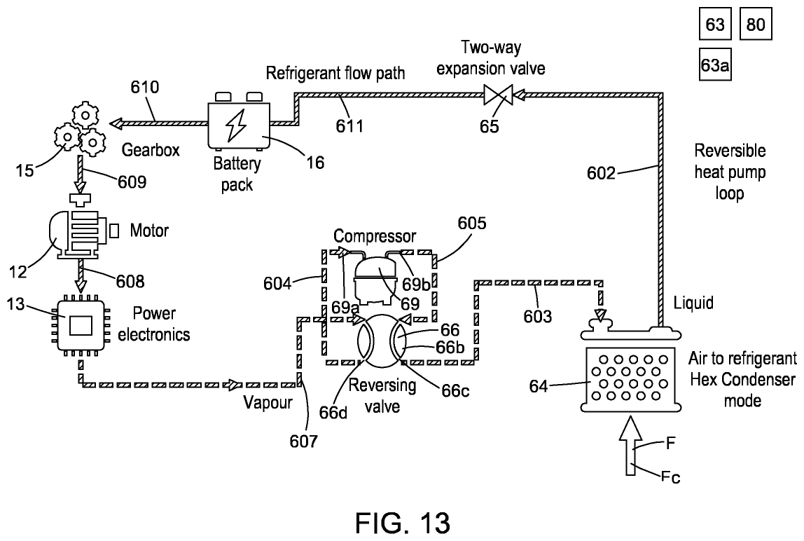

FIGS. 13, 14 and 15 show a further option for the heat exchange means 20 having only a heat pump 60. The heat pump 60 including a refrigerant circuit 62 connected to a refrigerant heat exchanger 64 for exchanging heat with the fluid F or collected fluid Fc. The heat pump 60 shown in FIGS. 13, 14 and 15 is a reversable heat pump 60 in the manner of the heat pump of FIGS. 10, 11 and 12 including a first heating mode 60a and a second cooling mode 60b, a reversing valve 66 for reversing the flow of the refrigerant circuit 62 and operable in a first position 66a during the first heating mode 60a and a second position 66b during the second cooling mode 60b. The heat pump 60 of FIGS. 13, 14 and 15 includes many of the same components as FIGS. 10, 11 and 12 and those components are numbered the same and have the same function. In particular second, third, fourth and fifth refrigerant connections 602, 603, 604, 605 are present and have the same connections and function as in FIGS. 10, 11 and 12. In addition, in FIG. 11 the battery pack 16, the power electronics 13, the gearbox 15 and the electric drive motor 12, together the thermally manged components 12, 13, 15, 16, are connected to the refrigerant circuit 62. There are included a seventh refrigerant connection 607 between the reversing valve 66 and the power electronics 13, an eighth refrigerant connection 608 between the power electronics 13 and the electric drive motor 12, a ninth refrigerant connection 609 between the motor 12 and the gearbox 15, a tenth refrigerant connection 610 between the gearbox 15 and the battery 16 and an eleventh refrigerant connection 611 between the battery 16 and the two way expansion valve 65.

As for FIGS. 10, 11 and 12 the reversing valve 66 of FIGS. 13, 14 and 15 includes a first reversing valve connection 66c and a second reversing valve connection 66d. Each reversing valve connection 66c, 66d fluidly connects one refrigerant connection 603, 604, 605, 607 to one other refrigerant connection 603, 604, 605, 607.

The heat pump 60 displayed in FIG. 13 is in the second cooling mode, the reversing valve 66 is in the second position 66b and includes the first reversing valve connection 66c between the third refrigerant connection 603 and the fifth refrigerant connection 605 connecting the high pressure output 69b of the compressor 69 with the refrigerant heat exchanger 64. The reversing valve 66 in the second position 66b further includes the second reversing valve connection 66d between the seventh refrigerant connection 607 and the fourth refrigerant connection 604 connecting the low pressure input 69a of the compressor 69 with the power electronics 13. Though it will be under stood that the connection could be between input 69a and any of the thermally managed components 12, 13, 15, 16. Thus, the high pressure output 69b of the compressor 69 is connected to the refrigerant heat exchanger 64, which is connected to the two way expansion valve 65 which is connected to the battery 16, which is connected to the gearbox 15, which is connected to the motor 12, which is connected to the power electronics 13, which is connected to the low pressure input 69a of the compressor 69. Refrigerant flows from the high pressure outlet 69b to the low pressure input 69a of the compressor 69. As there is only a refrigerant circuit 62 heat is exchanged directly between the thermally manged components and the refrigerant of the refrigerant circuit 62 by a local exchange means at each component for example directly via a passage 17 through the component as described above or through a thermal interface. Refrigerant will condense in the refrigerant heat exchanger 64 as it gives out heat energy to the fluid F or collected fluid Fc and evaporate in the local heat exchange means of the battery 16 or in any other of the thermally manged components when receiving heat energy from said thermally managed components 12, 13, 15, 16.

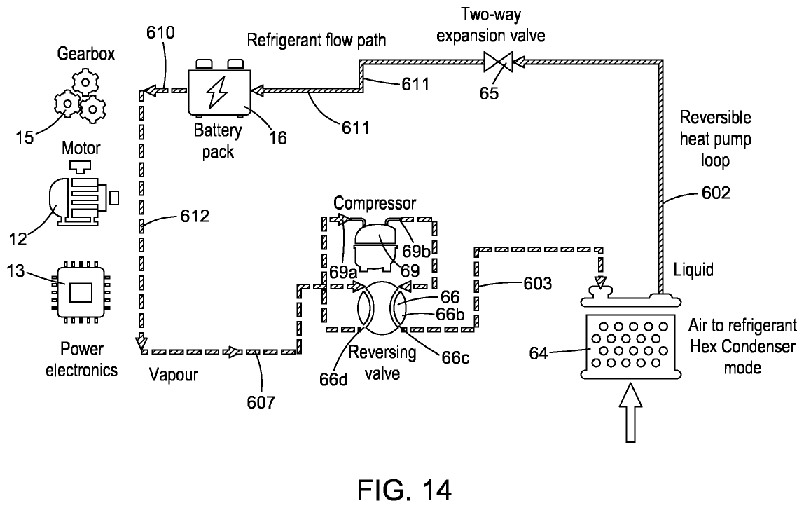

FIG. 14 shows the heat pump 60 of FIG. 13 with the refrigerant loop only connected to the battery 16. The refrigerant circuit 62 of FIG. 14 therefore includes a twelfth refrigerant connection 612 which joins or bridges the tenth refrigerant connection 610 and the seventh refrigerant connection 607 such that the gearbox 15 the motor 12 and the power electronics 13 are not included in the refrigerant circuit 62. This may be the only state for the refrigerant circuit 62, or the twelfth refrigerant connection 612 may be an optional bypass connection 612 controlled by the refrigerant flow control means 63 directly by a user or under the control of a refrigerant flow controller 63a.

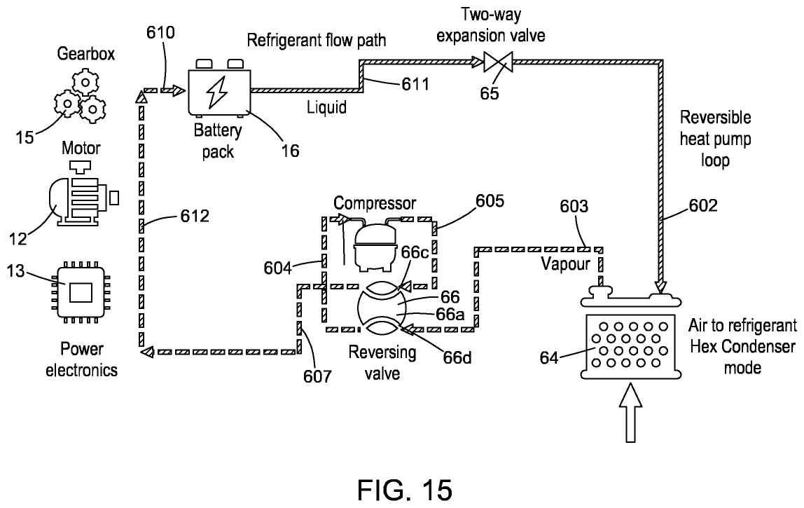

FIG. 15 shows the heat pump of FIG. 14 in the first heating mode 60a for exchanging heat from the fluid F or collected fluid Fc to at least the battery 16 and therefore with the reversing valve 66 in the first position 66a. In the first position 66a the first reversing valve connection 66c connects the fifth refrigerant connection 605 to the seventh refrigerant connection 607 and thus connects the high pressure output 69b of the compressor 69 to the battery pack 16. In the first position 66a the second reversing valve connection 66d connects the third refrigerant connection 603 with the fourth refrigerant connection 604 and thus connects the refrigerant heat exchanger 64 to the low pressure input 69a of the compressor 69. Thus, the high pressure output 69b of the compressor 69 is connected to the battery 16, which is connected to the two way expansion valve 65 which is connected to the refrigerant heat exchanger 64, which is connected to the low pressure input 69a of the compressor 69.

Refrigerant flows from the high pressure outlet 69b to the low pressure input 69a of the compressor 69. Refrigerant will condense in the battery 16 as it gives out heat energy and evaporate in the refrigerant heat exchanger 64 when receiving heat energy from the fluid F or collected fluid Fc. It will be understood that the refrigerant circuit 62 of FIG. 13 may also be used in the first heating mode 60a with the reversing valve in the first position 66a in which case the configuration would be similar to that of FIG. 15 but including all the thermally managed components 12, 13, 15, 16 in the same fashion as FIG. 13.

Whilst FIG. 15 shows the refrigerant circuit 62 in the first heating mode 60a connected to only the battery 16 it will be understood that the refrigerant circuit 62 configured as FIG. 15 can also operate in the first heating mode 60a and that any number of the thermally manged components can be included in the refrigerant circuit 60a between the seventh refrigerant connection 607 and the eleventh refrigerant connection 611.

In the embodiments, connection to the refrigerant circuit 62 comprises a fluid tight connection. The heat exchange means 20 may include a thermal interface for transfer of heat energy between the refrigerant circuit 62 and the one or more thermally managed components 12, 13, 15, 16. The heat exchange means 20 may include a passage 17 through the battery 16 and/or other thermally manged components for refrigerant of the refrigerant circuit 62 to pass through for direct transfer of heat energy between the battery 16 and said refrigerant. Alternatively, the heat exchange means 18 may include an intermediate thermal interface such as a heat sink for each thermally managed component 12, 13, 15, 16.

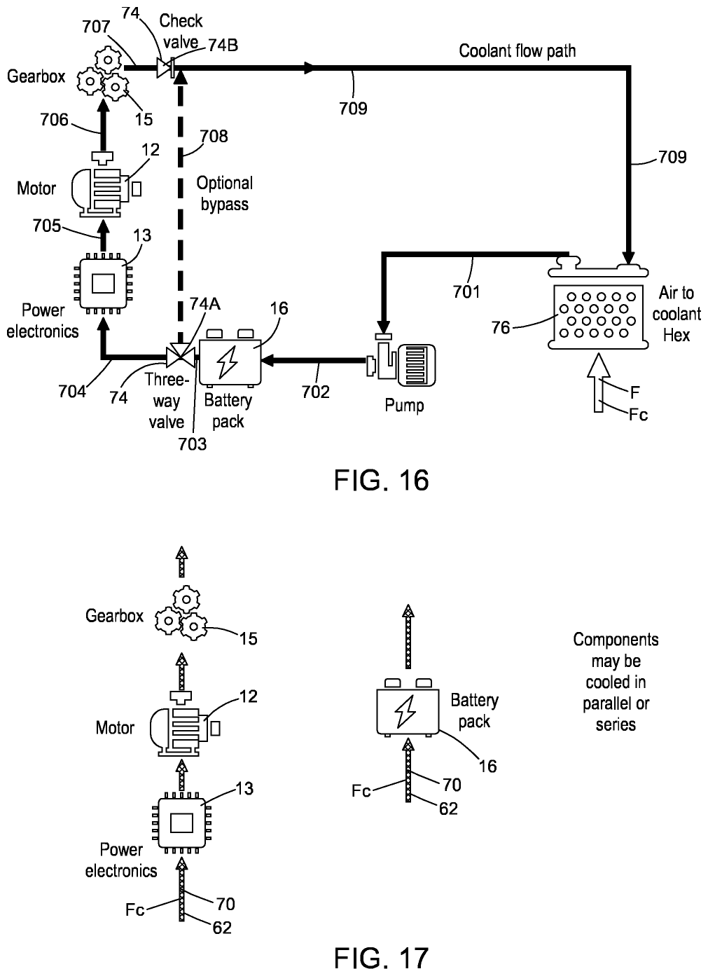

FIG. 16 shows a further alternative for the heat exchange means 20 including only a coolant circuit 70 for thermal management of at least the battery 16 and optionally the power electronics 13 the electric drive motor 12 and/or the gearbox 15, together the thermally managed components 12, 13, 15, 16. The coolant circuit of FIG. 16 includes the features of the coolant circuit 70 of FIG. 12 said features having the same reference numerals and the same function with the exception that the coolant heat exchanger 76 for transferring heat energy to and from the coolant circuit 70 includes transferring heat energy directly between the coolant circuit 70 and the fluid F or the collected fluid Fc. The coolant heat exchanger 76 is positioned in the flow of captured fluid Fc for transferring heat energy between the fluid F or the captured fluid Fc and the coolant circuit 70.

FIG. 17 displays an alternative arrangement for the cooling circuits 70, 62 of the thermally managed components 12, 13, 15, 16 shown in FIGS. 10 to 16 that are arranged in series and which may also be cooled in parallel in any of said previous arrangements. The parallel arrangement may apply to the coolant circuit 70 or the refrigerant circuit 62 of the heat pump 60 depending on which is connected to the thermally managed components 12, 13, 15, 16. The parallel arrangement can also apply to the flow of fluid F or fluid Fc used to cool the heat exchange means 20, with separate collected fluid being used to cool different components. In a preferred arrangement the battery pack 16 is cooled in parallel to the gearbox 15, motor 12 and the power electronics 13.

In the arrangements of FIGS. 10 to 17 a thermal storage device 80 may be included for temporary storage of heat energy when excess heat is generated. The heat energy absorbed by the thermal storage device may either be for later use or for stabilisation of the rate of thermal transfer load placed on the heat management system 18. The thermal storage device 80 may be included in the coolant circuit 70 or the refrigerant circuit 62. It is preferable that the thermal storage device 80 is included on the same circuit 62, 70 as the thermally managed components 12, 13, 15, 16. In a preferred arrangement the thermal storage device 80 includes a precooling connection 82 connectable to a cooler for pre-cooling the thermal storage device 80 to increase the heat capacity of said thermal storage device 80.

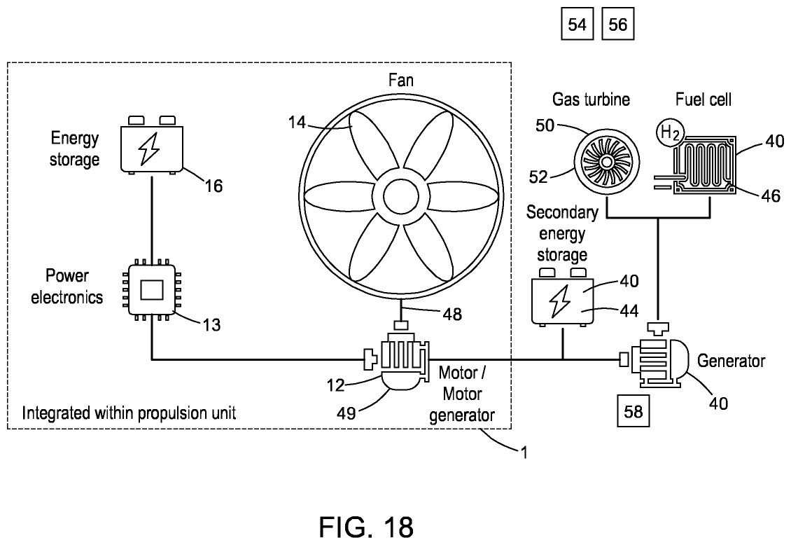

FIG. 18 shows a beneficial electrical lay out of a vehicle powered by a battery powered fan assembly 1 according to the current invention. The benefits of including the battery 16 or energy storage 16, the power electronics 13 and the electric drive motor 12 in an integrated assembly for use on a vehicle are discussed above. In particular in the preferred arrangement when that vehicle is an aircraft. Vehicles and aircraft in particular often consume power at a high rate to accelerate to a speed or climb to an altitude and once at an operating speed or altitude consume power at a much lower rate.

The battery powered fan assembly 1 may be used as the sole power unit for short journeys. However, for longer journeys an additional source of electricity 40 may be required electrically connected to and for supplying electricity to the electric drive motor 12 and/or for charging the battery 12.

FIG. 18 shows the battery powered fan assembly 1 including additional sources of electricity 40 including a generator 42, a second battery 44 and a hydrogen fuel cell 46. It will be understood that one or more of these additional sources of electricity 40 may be used. If a generator 42 is fitted a source of motive power 50 may be included to turn the generator 42 this may be a gas turbine 52 as shown in FIG. 18, an internal combustion engine 54 (not shown) or an external combustion engine 56 (not shown). Whilst use of such sources of motive power 50 may create pollutants that the use of the battery powered fan assembly 1 strives to avoid the use of the battery 16 to deliver power at the high rate when required allows the source of motive power 50 to be smaller and operate more efficiently at a fixed design speed.

The battery powered fan assembly 1 may further include a fan drive connection 58 between the source of motive power 50 and the fan 14 for driving the fan 14 directly. This may occur on occasions when it is more efficient to do so that to use the source of motive power 50 to power the generator to charge the battery.

The battery powered fan assembly 1 may further include a generator drive connection 48 between the fan 14 and the generator 42 for transferring motive power from the fan 14 to the generator 42 on occasions that the fan 14 is not being powered by the battery 16 and the flow of fluid F over the fan is driving the fan 14 to rotate. In a preferable arrangement the electrical drive motor 12 and the generator 42 may be combined in a single motor generator unit 49.

In use the battery 16 may be used as the sole power source for short journeys or powering a light craft. However, for a longer journey or if the vehicle or aircraft is larger or heavier the battery 16 may be used to provide the additional power for acceleration or for take-off and landing where the rate of power consumption is higher. The further source of electrical power 40 may then maintain supply of electricity at a lower rate to the motor 12 to power the fan 14.

It will be understood that the arrangement may be reversed with the battery 16 providing the sustained source and the boost being provided by the further source of electricity 40. The use of a source of motive power 50 driving a generator 42 is included as the energy density of combustible fuel is substantially greater than that of a battery 16 and may be helpful to reduce the weight of an aircraft allowing increased payload and/or range.

Whilst the application refers to a battery 16 and the second battery 44 it will be understood that battery 16, 44 may include any form of solid state electrical storage including capacitors 45, including super capacitors 45 and chemical electrical storage of any chemistry. Capacitors 45 and/or super capacitors 45 may be employed as the sole form of electrical energy storage of the battery 16 or may be used in combination with a chemical electrical storage in the battery 16 for storing and providing electricity into the fan assembly 1, for example, it may be beneficial to use capacitors 45 for receiving a fast charge immediately prior to a high load event such as during aircraft take off.

Any system feature as described herein may also be provided as a method feature, and vice versa. As used herein, means plus function features may be expressed alternatively in terms of their corresponding structure.

Any feature in one aspect, arrangement or embodiment may be applied to other aspects, arrangements or embodiments, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

1. A battery powered fan assembly for providing motive force, comprising:
an electric drive motor;
a motive fan for providing said motive force, connected to and driven by the drive motor and rotatable about a central axis X, for moving a fluid F and to thereby create a flow thereof;
a battery, electrically connected to and for powering the drive motor;
a heat management system, for managing the temperature T of the battery comprising:
a fluid collector, for collecting collected fluid Fc from the flow of fluid F moved by the motive fan;
a heat exchange means, for exchanging thermal energy between the collected fluid Fc and the battery; and
a fluid director for receiving collected fluid Fc from said fluid collector and directing said fluid Fc to said heat exchange means for thermal management of the battery.

2. The battery powered fan assembly as claimed in claim 1 and wherein said fan assembly further includes a housing having a surface, and an interior for housing said battery.

3. The battery powered fan assembly as claimed in claim 1 and wherein the fluid collector comprises an extractor for extracting a portion of the fluid F from the flow thereof.

4. The battery powered fan assembly as claimed in claim 3 and wherein said fluid extractor comprises a scoop extending into the flow of fluid F created by said fan or a flush intake duct below the surface.

5. The battery powered fan assembly as claimed in claim 3 and wherein and said extractor comprises an opening within the surface of the housing.

6. The battery powered fan assembly as claimed in claim 2 and wherein said housing is radially inward of the fan or wherein said housing is radially outward of the fan.

7. (canceled)

8. The battery powered fan assembly as claimed in claim 7 and wherein said housing comprises a circumferentially extending ring extending around the fan and forming an outer boundary confining the flow of any fluid F.

9. The battery powered fan assembly as claimed in claim 2 and wherein said heat exchange means is contained within the housing.

10. The battery powered fan assembly as claimed in claim 1, wherein the heat exchange means is a heatsink attached to the battery and in the flow of collected fluid Fc.

11. The battery powered fan assembly as claimed in claim 1 and further including a further source of electricity electrically connected to and for supplying electricity to said drive motor and/or charging said battery, wherein said further source of electricity includes a secondary battery, an electrical generator and/or a fuel cell.

12. (canceled)

13. (canceled)

14. (canceled)

15. The battery powered fan assembly as claimed in claim 13 and further including a source of motive power for driving said generator, optionally wherein said source of motive power comprises a gas turbine, internal combustion engine or external combustion engine.

16. (canceled)

17. The battery powered fan assembly as claimed in claim 15 further comprising a fan drive connection between the source of motive power and the fan for transferring motive power from the source of motive power to the fan for assisting the electric drive motor in driving the fan.

18. The battery powered fan assembly as claimed in claim 11, wherein said further source of electricity includes an electrical generator and further comprising a generator drive connection between the fan and the generator for driving the generator when the flow of fluid F is driving the fan, optionally wherein the electric drive motor and the generator are a combined motor generator.

19. (canceled)

20. The battery powered fan assembly as claimed in claim 1, wherein the battery or the second battery comprises capacitors or supercapacitors for storing and providing electricity to the fan assembly.

21. The battery powered fan assembly as claimed in claim 1, wherein the heat exchange means includes a heat pump having a refrigerant circuit connected to a refrigerant heat exchanger for exchanging heat energy between the refrigerant circuit and the collected fluid Fc.

22. (canceled)

23. (canceled)

24. (canceled)

25. The battery powered fan assembly as claimed in claim 1, wherein the heat exchange means includes a coolant circuit connected to and for exchanging heat energy with at least the battery and further connected to a coolant heat exchanger for transferring heat energy to or from the coolant circuit, wherein the coolant heat exchanger is positioned in the flow of captured fluid Fc for transferring heat energy between the captured fluid Fc and the coolant circuit.

26. (canceled)

27. (canceled)

28. (canceled)

29. (canceled)

30. The battery powered fan assembly as claimed in claim 2 and wherein the housing has a leading edge, a trailing edge and a return injector for receiving collected fluid Fc after it has been passed through the heat exchanger and returning it to the remainder of the fluid flow F at the trailing edge of the housing.

31. The battery powered fan assembly as claimed claim 21, wherein the heat exchange means includes a passage through the battery for coolant of the coolant circuit or refrigerant of the refrigerant circuit to pass through for direct transfer of heat energy between the battery and said coolant or refrigerant.

32. The battery powered fan assembly as claimed in claim 1, wherein the heat exchange means includes a passage through the battery for collected fluid Fc to pass through for exchange of thermal energy between the battery and the collected fluid Fc by direct transfer of heat from the battery to the collected fluid Fc.

33. The battery powered fan assembly as claimed in claim 1, further including a thermal storage device for temporary storage of heat energy.

34. The battery powered fan assembly as claimed in claim 33, wherein the thermal storage device includes a precooling connection connectable to a cooler for pre-cooling the thermal storage device to increase heat capacity.

35. (canceled)
